(19) United States
(12) Patent Application Publication
(10) Pub. No.: US 2026/0237323 A1
(43) Pub. Date: Aug. 13, 2026

(54) VIDEO CONFERENCING PLUG-IN FOR SIGN LANGUAGE COMMUNICATION

(71) Applicant: NVIDIA Corporation, Santa Clara, CA (US)

(72) Inventors: Michael Ross BOONE, Los Gatos, CA (US); Ruthie D. LYLE, Durham, NC (US); Nikki POPE, Henderson, NV (US); David Lee MARTIN, Mountain View, CA (US)

(21) Appl. No.: 19/332,433

(22) Filed: Sep. 18, 2025

Related U.S. Application Data
(60) Provisional application No. 63/756,438, filed on Feb. 10, 2025.

(51) Int. Cl. G09B 21/00; H04N 7/15

(52) U.S. Cl. CPC G09B 21/009; H04N 7/157

(57) ABSTRACT

In various examples, machine learning-based sign language translation for video conferencing platforms is provided. A video conferencing plug-in for sign language communication may instantiate sign language translation modules that translate incoming communication channel data from a first language mode (e.g., spoken language or sign language) to a target language mode corresponding to a sign language preference for the user. The video conferencing plug-in for sign language communication may control a user interface for a client application for the video conferencing platform to present at least a portion of an avatar performing signing corresponding to the sign language translation data based on control data generated by the video conferencing plug-in for sign language communication.

### CROSS-REFERENCE TO RELATED APPLICATIONS

This application claims the benefit of U.S. Provisional Application No. 63/756,438, filed on Feb. 10, 2025, the contents of which are hereby incorporated by reference in their entirety.

### BACKGROUND

Sign language translation represents a field of accessibility-focused technology for adapting digital platforms for better use by individuals with varying degrees of hearing difficulty. Sign language plays a crucial role in the lives of individuals who rely on it as their primary mode of communication. For these individuals, sign language is not just a tool for communication and expression but forms part of their identity and culture. However, the integration of sign language into technology presents unique challenges and opportunities. Deaf individuals, in particular, face a variety of challenges when it comes to technology accessibility. One of the main challenges is the lack of widespread support for sign language in digital platforms in order to engage with spoken language audio content and/or with other hearing individuals. This can lead to individuals experiencing a lack of independence and increased reliance on others, particularly hearing individuals, for assistance, which in turn can lead to a sense of exclusion and frustration from the lack of ability to fully engage with other individuals (including those speaking other sign languages) or access multimedia content using technology platforms.

Many technology platforms today provide communication channels through which groups of individuals can communicate with each other in order to collaborate on projects, exchange ideas and information, facilitate social interaction, and/or other purposes. Examples of such platforms include video conferencing platforms such as, but not limited to, Zoom, Cisco Webex, Microsoft Teams, Apple FaceTime, and the like. The human-machine interfaces (HMIs) implemented for such platforms typically include an audiovisual interface, where audio (e.g., voice) and image data are provided between meeting participants. The Deaf community has, in particular, typically been underserved by the HMIs provided by such platforms. Standard features of these HMIs may include real-time transcription and/or closed caption text that help a Deaf individual follow a spoken conversation, but the effectiveness of these technologies is often hampered by time delays and inaccuracies. Further, these technologies still fall short in that they do not address the challenge of permitting the Deaf individual to use sign language to effectively contribute to a real-time dialogue between participants. If a call is scheduled in advance, an interpreter may be hired that understands the desired sign language and can provide real-time interpretation during the video call. However, hiring an interpreter may be costly and requires advanced scheduling, which may not be possible and makes spontaneous meetings between signers of different languages and non-signers difficult.

### SUMMARY

Embodiments of the present disclosure relate to a video conferencing plug-in for sign language communication. Systems and methods are disclosed that may provide translation between spoken word and sign language and/or between different sign languages.

In contrast to conventional systems, the systems and methods presented in this disclosure utilize a video conferencing plug-in for sign language communication that may provide translation between spoken language and sign language and/or between different sign languages for a session (e.g., conference session) associated with a digital collaboration platform such as a video conferencing platform. The video conferencing plug-in for sign language communication may be enabled by a user (e.g., using a button, toggle switch, etc.), and one or more sign language translation modules may be instantiated for the session associated with the digital collaboration platform. Further the video conferencing plug-in for sign language communication may be automatically enabled. The sign language translation module(s) may be used to translate between a first language mode for incoming communication channel data (e.g., audio data and/or video data) that includes spoken language data or sign language data and a second language mode based on a language preference of a user. The translation data generated by the sign language translation module(s) may include sign language translation data that comprises a translation of sign language data or spoken language data into sign language based on the language preference of a user. The video conferencing plug-in for sign language communication may also control the digital collaboration platform to present a visual representation of the sign language translation data on a user interface (e.g., an embodied agent, such as an avatar, or portion thereof performing signing corresponding to sign language translation data). In some examples, the translation data may include spoken language translation data that comprises a translation of sign language data into spoken language based on at least language preference of the user, and an audible and/or textual representation of the spoken language translation data may be presented.

### BRIEF DESCRIPTION OF THE DRAWINGS

The present systems and methods for a video conferencing plug-in for sign language communication are described in detail below with reference to the attached drawing figures, wherein:

FIG. 1 is a data flow diagram for an example process for a sign language translation system, in accordance with some embodiments of the present disclosure;

FIG. 2 is a data flow diagram illustrating a sign language translation framework, in accordance with some embodiments of the present disclosure;

FIGS. 3A-3B are data flow diagrams illustrating example translation modes for sign language participants, in accordance with some embodiments of the present disclosure;

FIG. 4 is a data flow diagram illustrating example translation modes for non-sign language participants, in accordance with some embodiments of the present disclosure;

FIG. 5 is a flow chart illustrating an example method for a sign language translation system, in accordance with some embodiments of the present disclosure;

FIG. 6A is a block diagram of an example generative language model system suitable for use in implementing at least some embodiments of the present disclosure;

FIG. 6B is a block diagram of an example generative language model that includes a transformer encoder-decoder suitable for use in implementing at least some embodiments of the present disclosure;

FIG. 6C is a block diagram of an example generative language model that includes a decoder-only transformer architecture suitable for use in implementing at least some embodiments of the present disclosure;

FIG. 7 is a block diagram of an example computing device suitable for use in implementing at least some embodiments of the present disclosure; and

FIG. 8 is a block diagram of an example data center suitable for use in implementing at least some embodiments of the present disclosure.

### DETAILED DESCRIPTION

Systems and methods are disclosed related to a video conferencing plug-in for sign language communication. Some on-demand tools are available to facilitate conversations between signers and non-signers, but these are not real-time and are relay-based systems where spoken language or sign language is converted to text before translation. These current systems also generally require use of a standalone application, which may not be feasible or practical for widespread use at a company and would necessitate a Deaf individual and individuals they are communicating with to use a completely separate platform. With that in mind, forms of sign language recognition based on convolutional neural network (CNN) models have been proposed. However, these technologies have been substantially directed at classification of fingerspelling images rather than generating a true translation of conversational sign language and fall short of addressing multilingual scenarios. Therefore, currently available techniques do not provide fully accessible solutions for effective, real-time or near real-time video communication that support the different possible permutations of communication between signers of different languages and/or between signers and non-signers.

In contrast to conventional systems, such as those described above, the systems and methods presented in this disclosure use a video conferencing plug-in for sign language communication that may provide translation between spoken language and sign language and/or between different sign languages for a session associated with a communication platform (e.g., video conferencing platform) using one or more models. The video conferencing plug-in for sign language communication may be enabled by a user (e.g., using a button, toggle switch, etc.) or automatically enabled, and one or more sign language translation modules may be instantiated for the session associated with the communication platform. The sign language translation module(s) may be used to present audible and/or visual representations of translation data generated from incoming communication channel data (e.g., audio data and/or video data) that includes spoken language data or sign language data. The translation data may include sign language translation data that comprises a translation of incoming spoken language data or sign language data into sign language based on a language preference of the user, and a visual representation of the sign language translation data may be presented on a user interface (e.g., an embodied agent, such as an avatar, or portion thereof performing signing corresponding to sign language translation data). The translation data may include spoken language translation data that comprises a translation of sign language data into spoken language based on a language preference of the user, and an audible and/or textual representation of the spoken language translation data may be presented. The techniques described herein may be used to assist a user of communication platform in communicating with other participants in a live video conferencing session or during a recorded video communication session. The video conferencing plug-in for sign language communication may be used to aid users in business, education, public service, and other settings to facilitate communication between signers of different languages and/or between signers and non-signers.

The video conferencing plug-in for sign language communication may be integrated, for example, with a communication platform such as a video conferencing platform (e.g., Microsoft Teams, Zoom, Cisco Webex, Apple FaceTime, etc.) rather than operating as a standalone platform. The user interface for the video conferencing plug-in for sign language communication may embed directly into the user interface of the video conferencing platform, and the video conferencing plug-in for sign language communication may be enabled or activated within a client application (e.g., desktop or mobile application) for the video conferencing platform. For example, a user may enable the video conferencing plug-in for sign language communication using a button, toggle switch, or other feature within the client application for the video conferencing. In some embodiments, the integration of the video conferencing plug-in for sign language communication with the video conferencing platform may be implemented, at least in part, using one or more APIs.

A session associated with the communication platform may connect meeting participants using respective client applications that each generate communication channel data (e.g., audio and/or video feeds) that is distributed to the client applications of the other meeting participants. Each client application may receive one or more incoming feeds of communication channel data originating from the other meeting participants. For users that desire translation to/from sign language for one or more of the incoming feeds of communication channel data, the user may enable the video conferencing plug-in for sign language communication, and one or more sign language translation module(s) may be instantiated, where each sign language translation module may provide functionalities described herein for an individual feed of incoming communication channel data associated with a meeting participant. The sign language translation module(s) may process the communication channel data to generate translation data based on a language preference, which may indicate a preferred language (e.g., sign language or spoken language) for a user to have communication channel data presented to them. The language preference may be a setting that is selected by a user and/or inferred about the user (e.g., based on location information and/or detecting a language from audio, video, and/or image data). A visual representation of the translation data may then be presented to the user via the user interface of the client application for the communication platform using the language indicated by the language preference. The visual representation may comprise an embodied agent (e.g., an avatar) or a portion thereof.

The sign language translation module(s) may be implemented using an automatic speech recognition (ASR), Text-to-Speech (TTS), or Text-to-Text (TTT) software module that operates together with a dialogue manager (DM) software module and/or natural language processing artificial intelligence (AI). For example, the ASR, TTS, or TTT may be implemented using NVIDIA's Riva or Nemo. In some embodiments, the video conferencing plug-in for sign language communication may be implemented using a set of graphics processing unit (GPU)-accelerated multilingual speech and translation microservices that include sign-language-to-speech and/or speech-to-sign-language neural network machine translation services. In some embodiments, the sign language translation module(s) may generate a query to a microservices server based at least on communication channel data for a session and generate the sign language translation data based at least on query response data received from the microservices server in response to the query.

The language preference for a sign language participant may indicate that a sign language translation module should translate incoming communication channel data to a particular type of sign language (e.g., American Sign Language (ASL)). Where the incoming communication channel data includes spoken language data, the sign language translation module may be used to translate the spoken language data to sign language translation data based on the language preference for the sign language participant. Where the incoming communication channel data includes sign language data, the sign language translation module may be used to translate the sign language data to sign language translation data based on the language preference for the sign language participant. The video conferencing plug-in for sign language communication may generate a visual representation of the sign language translation data that may be presented to the sign language participant on a user interface of the client application for the communication platform. In some embodiments, the video conferencing plug-in for sign language communication may generate control data (e.g., control commands) for controlling animation of at least a portion (e.g., hands, face, etc.) of an embodied agent (e.g., avatar) to perform signing corresponding to the sign language translation data. The control data may be used to control the communication platform to present the avatar performing signing corresponding to the sign language translation data on the user interface for the client application.

In some embodiments, the video conferencing plug-in for sign language communication may generate the avatar (or a portion thereof) to be presented via the user interface of the communication platform, for example, based on features stored in a database and/or features derived from other content like a photograph, video data, or the like. The animation of the avatar may include emotion(s) (e.g., anger, joy, happiness, etc.), facial expression(s) (e.g., smile, frown, etc.), and/or body animation(s) (e.g., for hand(s), mouth, and/or other body part(s)) such that the avatar performs signing corresponding to the sign language translation data. In some examples, the animation may be implemented at least in part using Audio-to-Face or Audio-to-Emotion models. The video conferencing plug-in for sign language communication may adapt the control data to the user's cultural context by using profile information and/or previous conversations, which may help ensure that regional and colloquial variations are accurately represented by the animation of the avatar. In some embodiments, the avatar may be natively supported by the client application for the communication platform (e.g., via an avatars application or plug-in). The control data generated using the video conferencing plug-in for sign language communication may be made available through an API call and used to animate/control the avatar natively supported by the client application.

The language preference for a non-sign language participant may indicate that a sign language translation module should translate incoming communication channel data to a particular spoken language (e.g., English). Where the incoming communication channel data includes sign language data, the sign language translation module may be used to translate the sign language data to spoken language translation data based on the language preference for the non-sign language participant. The video conferencing plug-in for sign language communication may present an audible representation of the spoken language translation data to the non-sign language participant (e.g., via one or more speakers used for the client application). In some examples, the audible representation of the spoken language translation data may be indicative of emotion(s) (e.g., anger, joy, happiness, etc.), facial expression(s) (e.g., smile, frown, etc.), and/or body animation(s) (e.g., for hand(s), mouth, and/or other body part(s)) of the sign language participant.

In some embodiments, the video conferencing plug-in for sign language communication may generate a visual representation of the spoken language translation data that may be presented to the sign language participant on a user interface of the client application for the communication platform in addition to the audible presentation. For example, the video conferencing plug-in for sign language communication may generate control data (e.g., control commands) for controlling animation of an embodied agent, such as an avatar, to perform mouth movements (and other appropriate body animation(s)) corresponding to the spoken language translation data. The control data may be used to control the communication platform to present the avatar performing mouth movements (and other appropriate body animation(s)) that are synchronized with the audible representation. The video conferencing plug-in for sign language communication may generate and animate/control the avatar to be presented via the user interface of the communication platform in a manner similar to that described above.

In some embodiments, participant(s) (e.g., sign language participant and/or a non-sign language participant) of the session for the communication platform may enable use of an avatar to represent them on a user interface of a client application for the communication platform rather than present video data captured of them. For example, a sign language participant and/or non-sign language participant may enable an avatar that may imitate or otherwise simulate their facial and body movements based on captured audio data and/or video data. Control data may be generated to control animation of an avatar representing the participant that will be presented via user interfaces for client applications for the communication platform.

In some embodiments, the control data generated to control animation of an avatar may be provided as communication channel data in addition to, or instead of, audio data and/or video data discussed herein. The video conferencing plug-in for sign language communication may generate the sign language translation data or spoken language translation data based on the control data provided as the communication channel data. For example, where the control data is generated to control animation of an avatar that is simulating or mimicking the signing of a sign language participant, the video conferencing plug-in for sign language communication may generate sign language translation data (e.g., in a different sign language) or spoken language translation data based on that control data. Similarly, where the control data is generated to control animation of an avatar that is simulating the movement and spoken language of a non-sign language participant, the video conferencing plug-in for sign language communication may generate sign language translation data based on that control data.

Where multiple participants of the session for the communication platform have enabled an avatar to represent them, avatar-to-avatar communication may be utilized. Each of the sign language translation modules may generate translation data based on control data for the avatars representing the participants. In some embodiments, each of the receiving participants may be presented only with an avatar that communicates using the language indicated by the spoken or visual gesticular language preference for that respective receiving participant. For example, for a sign language participant, the communication platform may be controlled to present only an avatar performing signing in the preferred sign language for that sign language participant that corresponds to the sign language translation data generated from the control data for the avatar for the other participant, which may be a sign language participant or a non-sign language participant. Multiple avatars representative of a single participant may also be presented to a receiving participant, where the animation of a first avatar simulates the audio data and/or video data of another participant and the animation of a second avatar corresponds to the sign language translation data or the spoken language translation data generated using the sign language translation module.

In some embodiments, one or more models used by the video conferencing plug-in for sign language communication may be executed using a variety of different neural network architectures. For example, one or more models may comprise one or more encoder-decoder-based machine learning model architectures trained to perform sign language detection and translation functions, one or more generative artificial intelligence models (e.g., small language model (SLM)-based models, large language model (LLM)-based models, video and/or audio generation models, etc.), an avatar manager (e.g., to instantiate and control an avatar), and/or other types of models. In some embodiments, the sign language translation module(s) may be implemented using an artificial intelligence (AI)-based software framework (e.g., a suite of cloud-hosted AI models) such as, but not limited to, NVIDIA's ACE or Tokkio.

In some embodiments, the video conferencing plug-in for sign language communication may generate or augment the sign language translation data and/or spoken word translation data based on a recording of a session associated with the communication platform in addition to, or instead of, generating the sign language translation data and/or spoken word translation data in near real-time during the session. For example, a user may enable and use the video conferencing plug-in for sign language communication when watching a playback of a recording of the session (e.g., if the user was unable to attend the session live). The sign language translation module(s) may be instantiated and generate sign language translation data and/or spoken language translation data from the communication channel data (e.g., recording of the session). A visual representation of the sign language translation data and/or an audible representation of the spoken language translation data may be presented using the client application of the communication platform during playback of the recording in a manner similar to that described above.

Embodiments presented in the disclosure primarily refer to video conferencing platforms. However, it should be understood that techniques similar to those described herein may be used for other types of communication platforms that include video presentation such as, for example, cloud-based collaborative content creation platforms (e.g., NVIDIA Omniverse, NVIDIA Maxine, or other multi-user virtual environments), extended reality (XR) platforms that support virtual reality (VR) and/or augmented reality (AR) content, and/or other platforms supporting real-time or near real-time audio/video communications between user participants.

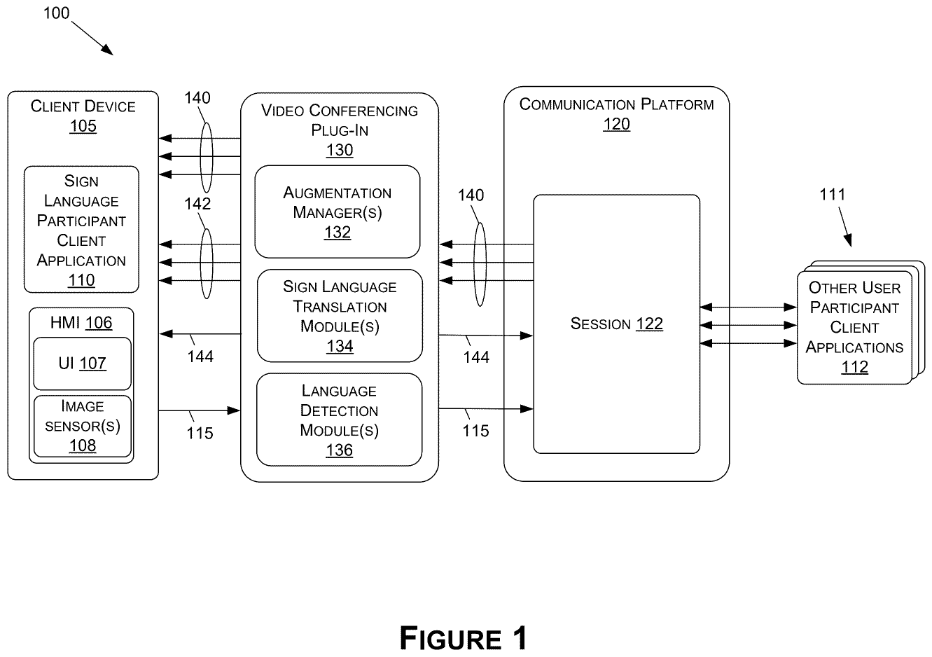

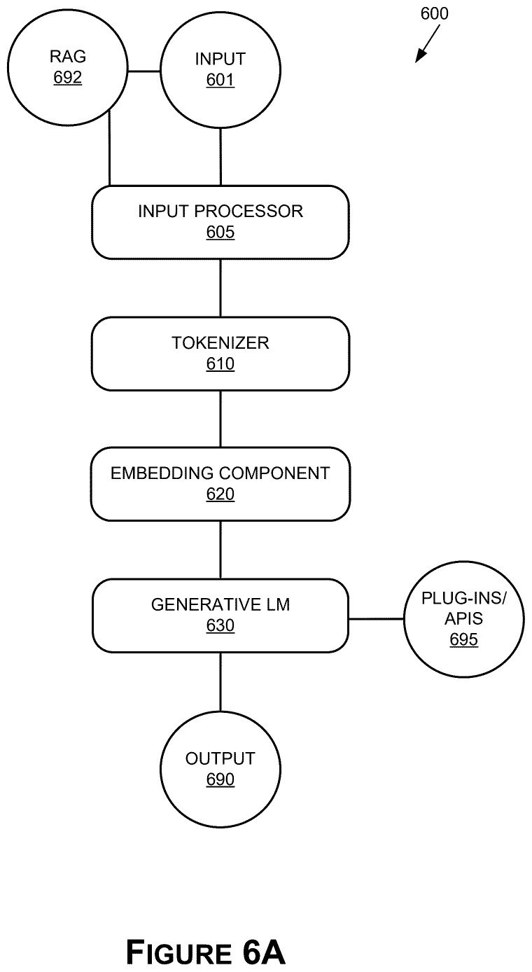

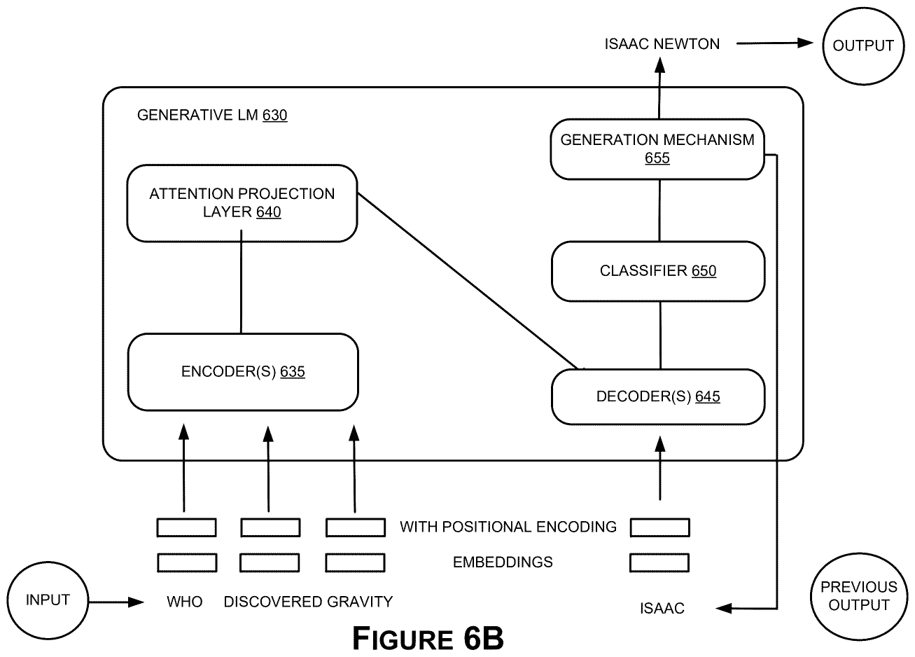

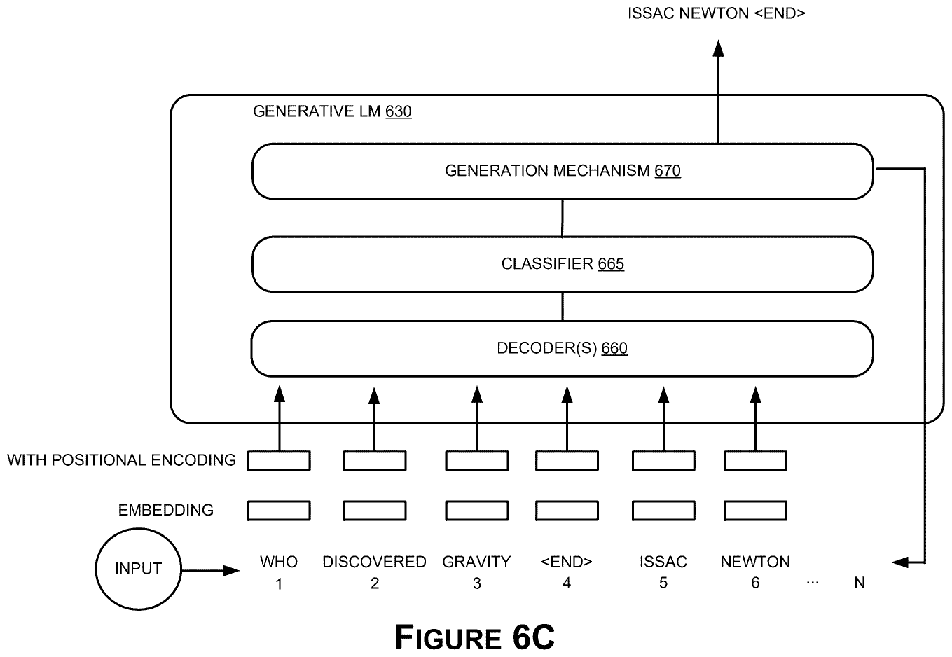

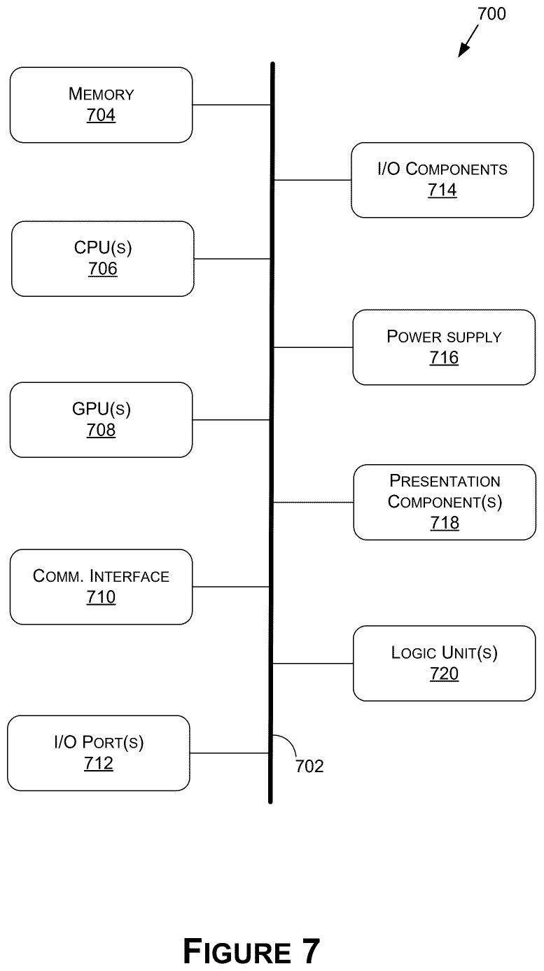

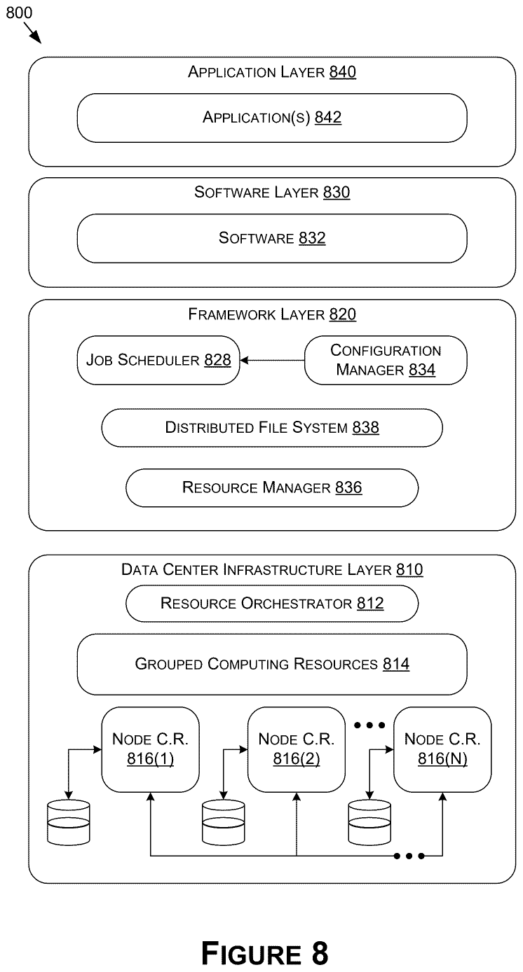

With reference to FIG. 1, FIG. 1 is an example sign language translation system 100, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out using one or more processors executing instructions stored in one or more memories. For example, in some embodiments, the system and methods described herein may be implemented using one or more generative language models (e.g., as described in FIGS. 6A-6C), one or more computing devices or components thereof (e.g., as described in FIG. 7), and/or one or more data centers or components thereof (e.g., as described in FIG. 8).

As shown in FIG. 1, the sign language translation system 100 may comprise one or more client devices 105 that couple to a communication platform 120 to instantiate one or more virtual communications channels to exchange audio/visual content within the context of a session 122 (e.g., a virtual conference or meeting, a virtual environment, etc.) hosted by the communication platform 120. The communication platform 120 may comprise, as non-limiting examples, a conferencing service (e.g., Microsoft Teams, Zoom, Cisco Webex, GoToMeeting, and the like), a cloud-based collaborative content creation platform (e.g., NVIDIA Omniverse, NVIDIA Maxine, or other multi-user virtual environments), and/or other platforms supporting real-time audio/video communications between user participants.

Generally, when the communication platform 120 initiates a conferencing meeting (e.g., a “call”), the communication platform 120 may establish an instance of the session 122. The session 122 defines a shared logical infrastructure established by the communication platform 120 that carries audio, video, image frames within video, text, and/or other forms of communications via a communication channel between a plurality of user participants who are attendees to the session 122. More specifically, a plurality of user participants (e.g., human users) may individually access the session 122 (e.g., via a networked connection) through their respective client applications 110 and 112, which may be executed by the user participants using various client devices 105 and 111 (such as the computing device 700 shown in FIG. 7). The client applications 110 and 112 may comprise, for example, a stand-alone video conferencing application (e.g., Microsoft Teams, Apple FaceTime, or other application) or a web browser application (e.g., Microsoft Edge) that accesses the session 122 via a web server (HTTP) protocol. For the purposes of the description, the client application discussed in detail with respect to FIG. 1 comprises a sign language participant client application 110. It should be understood that the client application may also comprise a spoken language participant client application, which may also be referred to as a non-sign language participant client application.

As illustrated in FIG. 1, a client device 105 may comprise a human-machine interface (e.g., HMI 106) through which a user may interact with the sign language participant client application 110. For example, the HMI 106 may comprise one or more of a keyboard, a pointing device, a touchscreen, a microphone, and/or other input interfaces for providing inputs to the sign language participant client application 110, and/or a display screen, speaker(s), and/or other output interfaces for providing content to the user from the sign language participant client application 110. In some embodiments, the client device 105 and/or the HMI 106 may comprise one or more image sensors 108 that capture image data of the user for transmission to the session 122 as an uplink communication channel data 115 (also referred herein as an outgoing channel data feed). In some embodiments, the uplink communication channel data 115 may comprise audio and/or video data captured from the user of sign language participant client application 110. As illustrated in FIG. 1, the HMI 106 may be controlled to display at least one user interface (UI) 107 generated by the sign language participant client application 110, which may display content received from other users of the session 122.

The sign language translation system 100 may include at least one video conferencing plug-in 130. The video conferencing plug-in 130 may be enabled by a user (e.g., using a button, toggle switch, etc.) using the HMI 106 and the UI 107 or may be automatically enabled (e.g., based on detection of different languages being communicated). As shown in FIG. 1, the video conferencing plug-in 130 may comprise a generative artificial intelligence-based augmentation manager 132 and may instantiate one or more machine learning model-based sign language translation modules 134 and one or more machine learning model-based sign language detection modules 136. As described herein, the video conferencing plug-in 130 operates to receive downlink communication channel data 140 (also referred herein as an incoming communication channel data feed) comprising one or more feeds of communication channel data (e.g., which may comprise voice, video, and/or data content). The communication channel data 140 may comprise, for example, data generated by one or more of the other participants of the session 122 using the other user participant client applications 112 and distributed to meeting participants by the communication platform 120. In some examples, the downlink communication channel data 140 may comprise a composite of individual downlink communication channel data feeds, where each individual downlink communication channel data feed represents communication data generated by individual participant client applications 112.

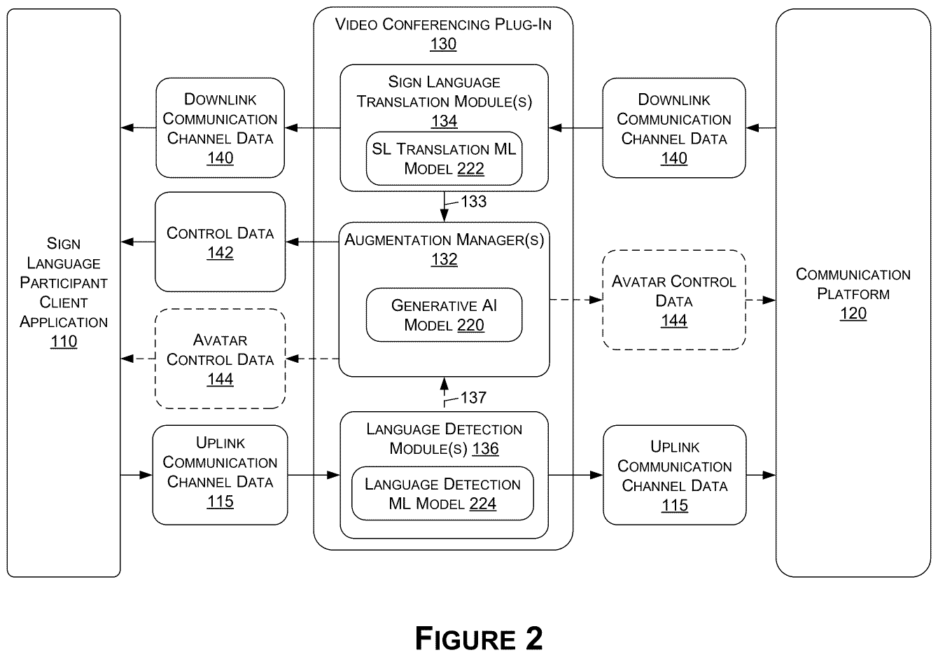

As described herein, and in more detail with respect to FIG. 2, for each individual downlink communication channel data feed, the video conferencing plug-in 130 may evaluate the individual communication channel data feed from the composite communication channel data 140 and determine which (if any) sign language translation functions are needed for that individual communication channel data feed. In some embodiments, the video conferencing plug-in 130 may instantiate a respective sign language translation module 134 for each individual communication channel data feed received by a participant client application for which sign language translation is activated. The sign language translation module 134 may generate sign language translation data based on the incoming language mode of the incoming communication data (e.g., whether a sign language or spoken language, and if so, which sign or spoken language) and a target language mode (e.g., a particular sign language) to be presented by the sign language participant client application 110 via the UI 107. For an individual communication channel data feed, a respective sign language translation module 134 for that feed may generate sign language translation data comprising a translation of the communication channel data based at least on a sign language user preference obtained from the sign language participant client application 110. For example, where the user of sign language participant client application 110 has elected to use ASL (e.g., set a sign language user preference to ASL), each instantiated sign language translation module 134 will translate individual communication channel data feed from the particular incoming language mode (whether a sign language or spoken language) into ASL to produce a respective feed of downlink sign language translation data that is delivered to the augmentation manager 132. Note that for an individual downlink communication channel data feed that already has an incoming language mode determined as matching the target language mode of the receiving user, the video conferencing plug-in 130 may allow that communication channel data feed to pass through the video conferencing plug-in 130 to the sign language participant client application 110 without further processing.

The augmentation manager 132 receives downlink sign language translation data from the one or more instantiated sign language translation modules 134 and, for each feed of downlink sign language translation data, generates control data 142 to control the UI 107 for the sign language participant client application 110 to present an avatar (or other virtual representation) performing signing corresponding to the sign language translation data. The avatar may be generated, for example, based on features stored in a database and/or features derived from other content like a photograph, video data, or other data for the user of the sign language participant client application 110. The control data 142 may be used by the sign language participant client application 110 to control animation of an avatar to perform signing corresponding to the sign language translation data, and the animation of the avatar may include emotion(s), facial expression(s), and/or body animation(s) (e.g., for hand(s), mouth, and/or other body part(s)). In some embodiments, the control data 142 may be generated, at least in part, using Audio-to-Face or Audio-to-Emotion models. The control data 142 may be adapted to the user's cultural context (e.g., based on profile information and/or previous conversations) to help ensure that regional and colloquial variations of the sign language are accurately represented by the animation of the avatar. In some embodiments, the avatar may be natively supported by the sign language participant client application 110 for the communication platform 120 (e.g., via an avatars application or plug-in). The control data 142 generated using the sign language translation module may be made available through an API call and used to animate/control the avatar natively supported by the client application.

In some examples, the augmentation manager 132 may augment the individual feeds of downlink communication channel data 140 provided to the sign language participant client application 110, for example, by modifying an individual communication channel data feed to include the avatar (e.g., where the avatar is not natively supported by the sign language participant client application 110). The individual feeds of downlink communication channel data 140 may be modified to overlay the avatar onto a live streaming video feed presented to the user by the UI 107. The video conferencing plug-in 130 may provide the control data 142 to control animation of the avatar overlaid onto the live streaming video feed presented to the user by the UI 107 to perform signing corresponding to the sign language translation data in a manner similar to that discussed above.

Referring now to FIG. 2, FIG. 2 is an example data flow diagram illustrating a video conferencing plug-in 130, in accordance with some embodiments of the present disclosure. As discussed with respect to FIG. 1, the video conferencing plug-in 130 may process one or more streams (e.g., feeds) of downlink communication channel data 140 from the communication platform 120 to produce control data 142 provided to the sign language participant client application 110 to control the UI 107 to display a visual representation of the sign language translation data.

As further illustrated in FIG. 2, the video conferencing plug-in 130 may instantiate one or more sign language translation modules 134 to translate downlink communications channel data 140 into a target language mode. In some embodiments, the video conferencing plug-in 130 may instantiate dedicated sign language translation modules 134 for individual communication channel data feeds to be translated to the target language mode. In some embodiments, a sign language translation module 134 may be instantiated to process a plurality of individual communication channel data feeds for translation to a target language mode.

As previously discussed, a target language mode for a sign language translation module 134 may be determined based on information obtained from the sign language participant client application 110. For example, in some embodiments, sign language translation module 134 may input an indication of sign language preference setting data received from the sign language participant client application 110 (e.g., as indicated in a user profile). The user of sign language participant client application 110 may set a sign language user preference by selecting a preferred sign language (e.g., from a list of potential languages), and the sign language translation module 134 may input the sign language user preference and generate sign language translation data 133 based on the indicated selections. For example, in some embodiments, the sign language preference setting data may indicate a selection of a preferred sign language (e.g., ASL). In that case, the video conferencing plug-in 130 may instantiate the one or more sign language translation engine modules 134 with a target language mode configuration that translates downlink communication channel data 140 into that selected preferred sign language (e.g., ASL). In other words, downlink communication channel data 140 comprising spoken word data and/or sign language data based on a different sign language (e.g., British Sign Language (BSL), French Sign Language (LSF), or another non-ASL sign language) will be translated into the preferred sign language.

As another example, in some embodiments, a language detection module 136 of the video conferencing plug-in 130 may infer the sign language user preference based on processing uplink communication channel data 115 received from the sign language participant client application 110. For example, the language detection module 136 comprises a language detection model 224 comprising a machine learning model trained to infer from image data and/or video data when a sign language is being used and classify which sign language is being used. As such, the video conferencing plug-in 130 may detect that sign language translation services are needed based on evaluating the uplink communication channel data 115 that the sign language participant client application 110 is transmitting to the communication platform 120. In some embodiments, the video conferencing plug-in 130 (e.g., using a language detection model 224) may infer a sign language preference based on various context available from the uplink communication channel data 115. For example, the video conferencing plug-in 130 may use facial and gesture detection, non-manual signals, background noise, or other data to infer the language preference of the user of the sign language participant client application 110. Based on the language detection model 224 determining when a sign language is being/to be used and which sign language is being used or preferred, the video conferencing plug-in 130 may instantiate the one or more sign language translation modules 134 with a target language mode configuration that translates downlink communication channel data 140 into that preferred sign language (e.g., ASL). Downlink communication channel data 140 comprising spoken word data and/or sign language data based on a different sign language (e.g., BSL, LSF, or another non-ASL sign language) will be translated into data presented in the preferred sign language.

In some embodiments, a sign language participant of the session 122 for the communication platform 120 may enable use of an avatar to represent them. For example, rather than presenting video data of the sign language participant captured by the one or more image sensors 108, the user interface of the client applications 110 and 112 for participants of the session 122 will present an avatar representing the sign language participant instead. For example, a sign language participant may enable an avatar that may imitate or otherwise simulate their facial and body movements based on captured video data. In some examples, the language detection module 136 may generate uplink language detection data 137 from the uplink communication channel data 115. The uplink language detection data 137 may comprise data indicative of the determined meaning of various signs made by the user of the sign language participant client application 110 that are captured in the uplink communication channel data 115.

The augmentation manager 132 may receive the uplink language detection data 137 from the language detection module 136 and generate avatar control data 144 to control the UI 107 for the sign language participant client application 110 to present an avatar representing the user of the sign language participant client application 110. The avatar control data 144 may be used by the sign language participant client application 110 to control animation of the avatar representing the user of the sign language participant client application 110 to perform signing corresponding to the uplink language detection data 137, and the animation of the avatar may include emotion(s), facial expression(s), and/or body animation(s) (e.g., for hand(s), mouth, and/or other body part(s)). In some embodiments, the avatar may be natively supported by the sign language participant client application 110 for the communication platform 120 (e.g., via an avatars application or plug-in). The avatar control data 144 generated using the sign language translation module may be made available through an API call and used to animate/control the avatar natively supported by the client application.

In the example shown in FIG. 2, the avatar control data 144 generated to control animation of the avatar representing the user of the sign language participant client application 110 may be provided as uplink communication channel data 115 in addition to, or instead of, audio data and/or video data discussed herein. A sign language translation module may generate the sign language translation data or spoken language translation data based on the control data generated to control animation of an avatar. For example, where the control data is generated to control animation of an avatar that is simulating the signing of a sign language participant, the sign language translation module may generate sign language translation data (e.g., in a different sign language) or spoken language translation data based on that control data. Similarly, where the control data is generated to control animation of an avatar that is simulating the movement and spoken language of a non-sign language participant, the sign language translation module may generate sign language translation data based on that control data.

Where multiple participants of the session 122 have enabled an avatar to represent them, avatar-to-avatar communication may be utilized. In the example shown in FIG. 2, the downlink communication channel data 140 may include avatar control data and the sign language translation module 134 may generate sign language translation data 133 based on the avatar control data. For example, the sign language translation module 134 may translate the avatar control data received as the downlink communication channel data 140 into sign language translation data 133 and then the augmentation manager 132 may generate the control data 142. In some embodiments, each of the participants may be presented only with an avatar that communicates using the language indicated by the language preference (e.g., spoken or visual gesticular language preference) for that respective participant. For example, for a sign language participant, the communication platform may be controlled to present only an avatar performing signing in the preferred sign language for that sign language participant that corresponds to the sign language translation data generated from the avatar control data from the other participant, which may be a sign language participant or a non-sign language participant. In some examples, multiple avatars representative of a single participant may be presented to a receiving participant, where the animation of a first avatar simulates the audio data and/or video data of another participant and the animation of a second avatar corresponds to the sign language translation data or the spoken language translation data generated using the sign language translation module.

The one or more sign language translation modules 134 and the one or more sign language detection modules 136 may be implemented using one or more machine learning models that may comprise one or more different neural network architectures. The machine learning model(s) may comprise, for example, one or more encoder-decoder-based machine learning model architectures trained to perform sign language detection and translation functions and/or one or more generative artificial intelligence models (e.g., a small language model (SLM)-based model, vision language model (VLM), and/or an LLM-based model). A sign language translation module 134 and some language detection modules 136 may include an automatic speech recognition (ASR), Text-to-Speech (TTS), or Text-to-Text (TTT) software module that operates together with a dialogue manager (DM) software module and/or natural language processing artificial intelligence (AI). For example, the ASR, TTS, or TTT may be implemented using NVIDIA's Riva or Nemo. In some examples, a language detection module 136 may include one or more models trained for facial and gesture detection for one or more sign languages. In some embodiments, a sign language translation module 134 and/or a language detection module 136 may be implemented using a set of graphics processing unit (GPU)-accelerated multilingual speech and translation microservices that include speech-to-text and/or sign-language-to-speech neural machine translation services and in some embodiments, may produce prompts used to interface with one or more language models accessible to the video conferencing plug-in 130 and/or to the one or more sign language translation modules 134.

The augmentation manager 132 may be implemented using one or more generative artificial intelligence models 220 (e.g., small language model (SLM)-based models, LLM-based models, video and/or audio generation models, and/or an avatar manager (e.g., to instantiate and control an avatar)) that generate the control data 142 and/or augment the downlink communication channel data 140. For example, in some embodiments, the generative artificial intelligence model(s) 220 may input as prompts the downlink sign language translation data 133 from the one or more instantiated sign language translation modules 134 and generate the control data 142 described herein. In some embodiments, the one or more models of the video conferencing plug-in 130 may be implemented at least in part using an artificial intelligence (AI)-based software framework (e.g., a suite of cloud-hosted AI models) such as, but not limited to, NVIDIA's Avatar Cloud Engine (ACE) or Tokkio.

Further, while the video conferencing plug-in 130 is described primarily with respect to real-time or near real-time video conferencing using the communication platform 120, it should be understood that the video conferencing plug-in 130 may generate the sign language translation data 133 based on a recording of a session 122 associated with the communication platform 120 in addition to, or instead of, generating the sign language translation data 133 in real-time or near real-time during the session 122. For example, a user may enable and use the video conferencing plug-in 130 when watching a playback of a recording of the session 122 (e.g., if the user was unable to attend the session live). The sign language translation module(s) 134 may be instantiated and generate sign language translation data 133 from the communication channel data 140 (e.g., recording of the session 122). A visual representation of the sign language translation data 133 may be presented using the UI 107 of the sign language participant client application 110 during playback of the recording in a manner similar to that described above.

While FIGS. 1-2 specifically discuss a sign language participant client application 110, it should be understood that users of the communication platform 120 may also comprise non-sign language participants. For example, the non-sign language participants may select a language preference for a particular spoken language (e.g., German) rather than a sign language, and the video conferencing plug-in 130 may instantiate one or more sign language translation modules 134 that translate the downlink communication channel data 140 to generate spoken language translation data. The augmentation manager 132 may generate control data 142 in such embodiments, which may comprise control commands for controlling an avatar (e.g., lip movement, etc.) and providing audible spoken language data that may be emitted, for example, from a speaker of the HMI 106. In some embodiments, a composite of the downlink communication channel data 140 and the control data 142 produced by the augmentation manager 132 (e.g., the augmented video data and/or audible spoken language data) may be output from the video conferencing plug-in 130 and provided as downlink translated data feeds.

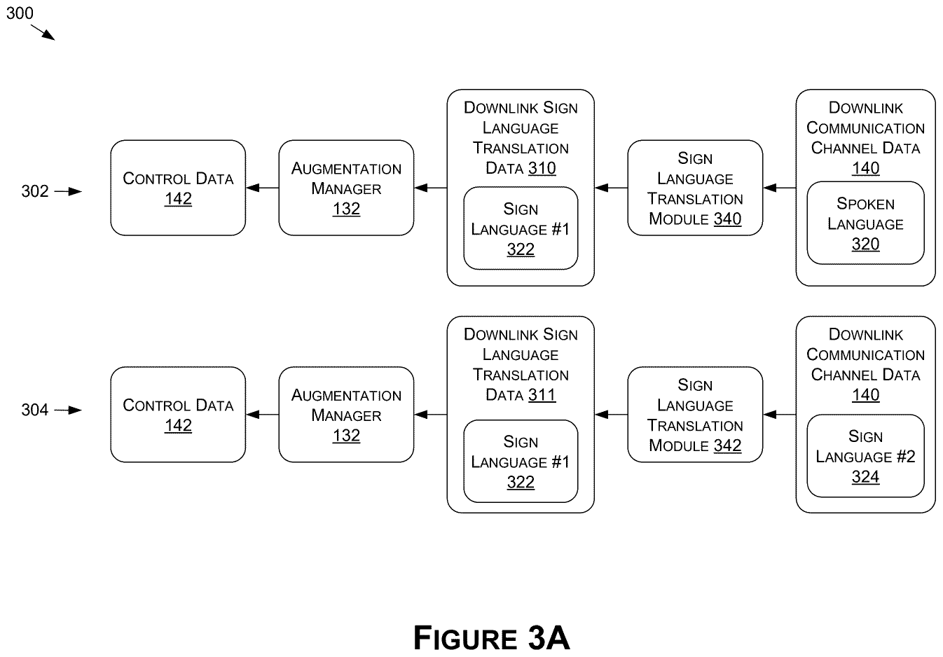

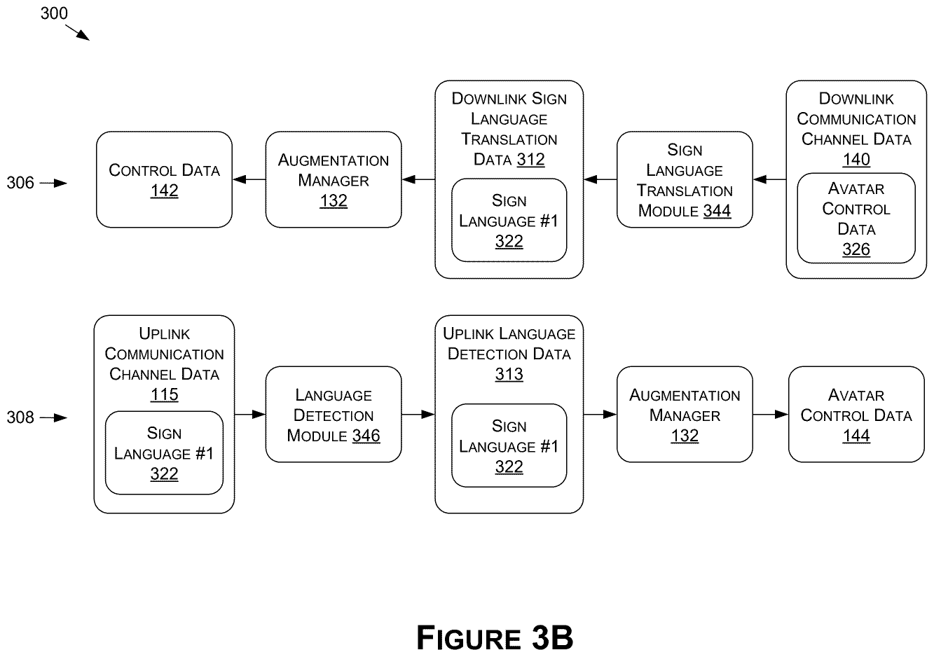

Referring now to FIGS. 3A-3B, FIGS. 3A-3B illustrate a data flow diagram 300 illustrating example translation modes for sign language participants, in accordance with embodiments of the present disclosure. FIGS. 3A-3B illustrate example operations of sign language translation modules translating incoming communication channel data 140 from a first mode to a target language mode and example operations for generating avatar control data 144 from video data captured by one or more image sensors 108 of the client device 105.

As a first example at 302, a sign language translation module 340 receives downlink communication channel data 140 comprising spoken language data 320. Based on an obtained sign language user preference, the video conferencing plug-in 130 determines that the target language mode is a first sign language 322 (e.g., ASL). Accordingly, the sign language translation module 340 translates the spoken language data 320 into downlink sign language translation data 310 comprising the first sign language 322. The downlink sign language translation data 310 may be provided (e.g., as a prompt) to the augmentation manager 132, which generates control data 142 to control animation of an avatar to perform signing corresponding to the sign language translation data 310.

As a second example at 304, a sign language translation module 342 receives downlink communication channel data 140 comprising second sign language data 324 (e.g., LSF). Based on an obtained sign language user preference, the video conferencing plug-in 130 has determined that the target language mode is the first sign language 322 (e.g., ASL). Accordingly, the sign language translation module 342 translates the second sign language data 324 into downlink sign language translation data 311 comprising the first sign language 322. The downlink sign language translation data 311 may be applied as a prompt to the augmentation manager 132, which generates control data 142 to control animation of an avatar to perform signing corresponding to the sign language translation data 311.

As a third example at 306, a sign language translation module 344 receives downlink communication channel data 140 comprising avatar control data 326. The control data 326 may comprise control commands to control an avatar to perform sign language or to control an avatar to perform a spoken language (e.g., lip movement, etc.). Based on an obtained sign language user preference, the video conferencing plug-in 130 has determined that the target language mode is the first sign language 322 (e.g., ASL). Accordingly, the sign language translation module 344 translates the avatar control data 326 into downlink sign language translation data 312 comprising the first sign language 322. The downlink sign language translation data 312 may be provided (e.g., as a prompt) to the augmentation manager 132, which generates control data 142 to control animation of an avatar to perform signing corresponding to the sign language translation data 312.

As a fourth example at 308, a language detection module 346 receives uplink communication channel data 115 comprising video data of a user performing first sign language 328. The language detection module 346 determines which sign language is being used in the uplink communication channel data 115 and generates uplink language detection data 313 comprising the first sign language 322. The uplink language detection data 313 may be indicative of the meaning of the signs detected in the video data of the user performing the first sign language. The uplink sign language translation data 313 may be provided (e.g., as a prompt) to the augmentation manager 132, which generates avatar control data 144 to control animation of an avatar to perform signing corresponding to the uplink language detection data 313. In some embodiments, such as where the user has selected to be represented by an avatar, the avatar control data 144 may be provided back to the sign language participant client application 110 to control animation of an avatar on the UI 107 of the sign language participant client application 110 and/or may be provided to the session 122 and on to other client applications 112 to control animation of an avatar on the UI of those client applications 112.

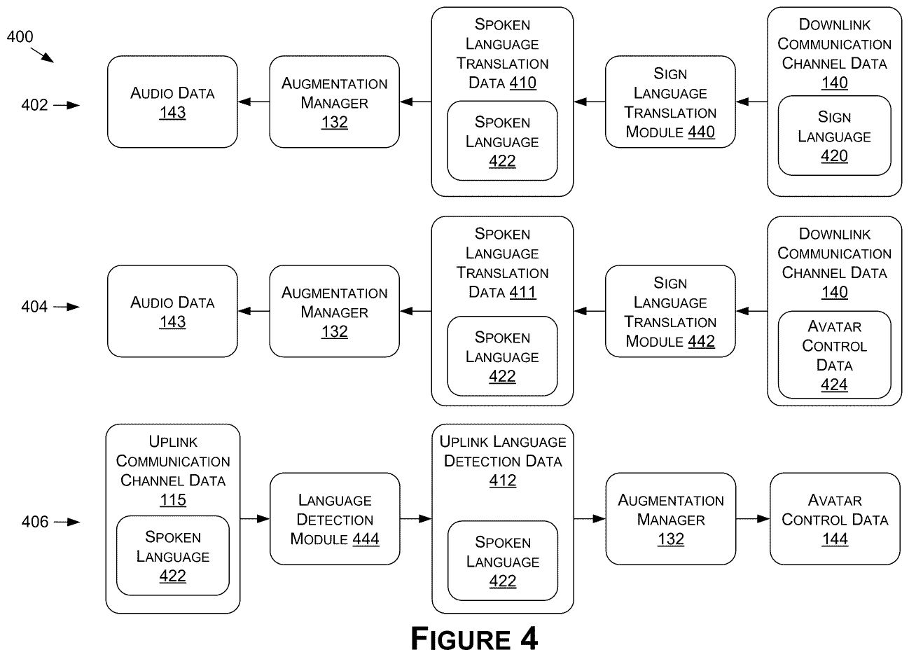

Referring now to FIG. 4, FIG. 4 is a data flow diagram 400 illustrating example translation modes for non-sign language participants, in accordance with embodiments of the present disclosure. FIG. 4 illustrates example operations of sign language translation modules translating incoming communication channel data 140 from a first mode to a target language mode and example operations for generating avatar control data 144 from audio and video data captured by one or more image sensors 108 of the client device 105.

As a first example at 402, a sign language translation module 440 receives downlink communication channel data 140 comprising sign language data 420 (e.g., LSF). Based on an obtained language preference for a user, the video conferencing plug-in 130 has determined that the target language mode is a spoken language 422 (e.g., English). Accordingly, the sign language translation module 440 translates the sign language data 420 into spoken language translation data 410 comprising the spoken language 422. The spoken language translation data 410 may be provided (e.g., as a prompt) to the augmentation manager 132, which generates audio data comprising the spoken language 422 and control data 142 to control animation of an avatar to perform speaking and gestures corresponding to the spoken language translation data 410.

As a second example at 404, a sign language translation module 442 receives downlink communication channel data 140 comprising avatar control data 424. The control data 424 may comprise control commands to control an avatar to perform sign language or to control an avatar to perform a spoken language (e.g., lip movement, etc.). Based on an obtained language preference for a user, the video conferencing plug-in 130 has determined that the target language mode is a spoken language 422 (e.g., English). Accordingly, the sign language translation module 442 translates the avatar control data 424 into spoken language translation data 411 comprising the spoken language 422. The spoken language translation data 411 may be provided (e.g., as a prompt) to the augmentation manager 132, which generates audio data comprising the spoken language 422 and control data 142 to control animation of an avatar to perform speaking and gestures corresponding to the spoken language translation data 411.

As a third example at 406, a language detection module 444 receives uplink communication channel data 115 comprising audio and video data of a user speaking a spoken language 422. Based on an obtained sign language user preference, the video conferencing plug-in 130 has determined that the target language mode is a spoken language 330 (e.g., English). Accordingly, the language detection module 444 generates the uplink language detection data 412 into downlink sign language translation data 312 comprising the spoken language 330. The downlink sign language translation data 312 may be applied as a prompt to the augmentation manager 132, which generates augmentation content comprising spoken language audio as control data 142 representing an audible translation of the sign language translation data.

The language detection module 444 determines which language is being spoken in the uplink communication channel data 115 and generates uplink language detection data 412 comprising the spoken language 422. The uplink language detection data 412 may be indicative of the meaning of the words detected in the audio and video data of the user speaking the spoken language. The uplink language detection data 412 may be provided (e.g., as a prompt) to the augmentation manager 132, which generates avatar control data 144 to control animation of an avatar to perform speaking and gestures corresponding to the uplink language detection data 412 corresponding to the uplink language detection data 412. In some embodiments, such as where the user has selected to be represented by an avatar, the avatar control data 144 may be provided back to the non-sign language participant client application to control animation of an avatar on the UI of the non-sign language participant client application and/or may be provided to the session 122 and on to other client applications 112 to control animation of an avatar on the UI of those client applications 112.

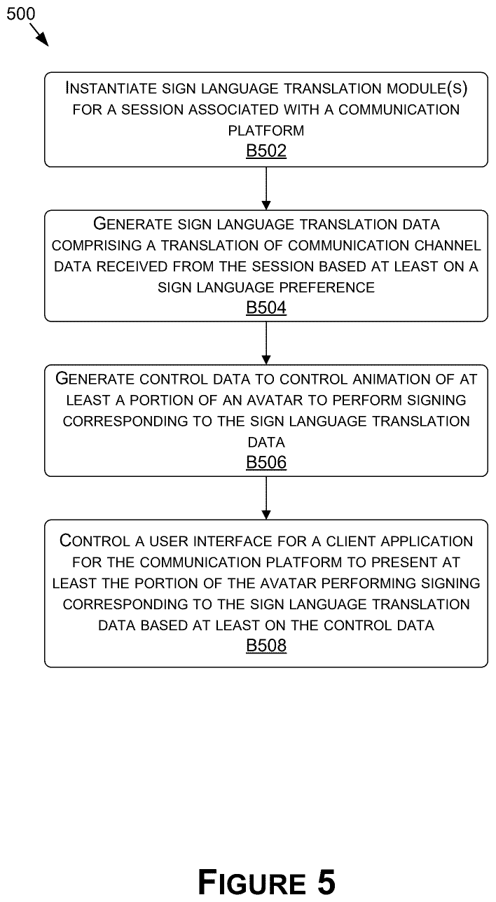

Now referring to FIG. 5, FIG. 5 is a flow diagram showing a method 500 for sign language translation, in accordance with some embodiments of the present disclosure. Each block of method 500, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 500 is described, by way of example, with respect to the system of FIGS. 1-2. However, this method may additionally or alternatively be executed by any one system, or any combination of systems, including, but not limited to, those described herein.

The method 500, at block B502, includes instantiating one or more sign language translation modules for a session associated with a communication platform. As discussed herein, a user may enable the video conferencing plug-in 130, for example, using a button, toggle switch, or other mechanism when translation between sign language and spoken language and/or between different sign languages is desired. The video conferencing plug-in 130 may be automatically enabled in some examples based on detection of different languages being used by various participants. In some embodiments, the video conferencing plug-in 130 may instantiate a respective sign language translation module 134 for each feed of incoming communication channel data 140 from the session 122 for the communication platform 120. For example, if a user of the sign language participant client application 110 is communicating with two other participants during the session 122, a respective sign language translation module 134 may be instantiate for the downlink communication channel data 140 from each of the other participants.

The method 500, at block B504, includes generating sign language translation data comprising a translation of communication channel data received from the session based at least on a sign language preference of a user. As discussed herein, a sign language preference of the user may be provided by the user of the sign language participant client application 110 based on a selection of a preferred sign language. In some examples, the user may select the preferred sign language from a list of available options supported by the video conferencing plug-in 130. In some embodiments, the sign language preference of the user may be inferred from uplink communication channel data 115 provided by the sign language participant client application 110. For example, a language detection module 136 may detect a particular type of sign language being used by the user of the sign language participant client application 110 and select that particular type of sign language as the sign language preference of the user without the user explicitly making a selection.

Each sign language translation module 134 may generate sign language translation data 133 based on the incoming language mode of the incoming communication channel data 140 (e.g., whether a sign language or spoken language, and if so, which sign or spoken language) and a target language mode corresponding to the sign language preference for the user. The sign language translation data 133 may comprise a translation of the downlink communication channel data 140 from the incoming language mode to the target language mode corresponding to the sign language preference for the user. For example, where the user of sign language participant client application 110 has elected to use ASL (e.g., set a sign language preference to ASL), each instantiated sign language translation module 134 will translate a feed of downlink communication channel data 140 from the particular incoming language mode (whether a sign language or spoken language) into ASL to produce a respective feed of downlink sign language translation data 133.

The method 500, at block B506, includes generating control data to control animation of at least a portion of an avatar to perform signing corresponding to the sign language translation data. The sign language translation module(s) 134 may provide the sign language translation data 133 to an augmentation manager 132, and the augmentation manager 132 may generate the control data 142, which may comprise control commands that may be used to control animation of an avatar to perform signing corresponding to the sign language translation data. The animation of the avatar may include emotion(s), facial expression(s), and/or body animation(s) (e.g., for hand(s), mouth, and/or other body part(s)). In some examples, the control data 142 may be adapted to the user's cultural context (e.g., based on profile information and/or previous conversations) to help ensure that regional and colloquial variations of the sign language are accurately represented by the animation of the avatar. The control data 142 generated using the sign language translation module(s) 134 may be made available through an API call.

The method 500, at block B508, includes controlling a user interface for a client application for the communication platform to present the portion of the avatar performing signing corresponding to the sign language translation data based at least on the control data. The sign language participant client application 110 may generate the avatar, for example, using a natively supported avatars application or plug-in for the sign language participant client application 110 and control the animation of the avatar to perform signing corresponding to the sign language translation data 133 using the control data 142. The avatar may be generated, for example, based on features stored in a database and/or features derived from other content like a photograph, video data, or other data for the user of the sign language participant client application 110. The generated avatar will perform sign language corresponding to the sign language preference for the user. In some embodiments, the avatar may be overlaid onto a live streaming video feed presented to the user by the UI 107 or the avatar may appear in a separate window of the UI 107 of the sign language participant client application 110.

The systems and methods described herein may be used for a variety of purposes, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, augmented reality (AR), virtual reality (VR), mixed reality (MR), robotics, security and surveillance (e.g., in a smart cities implementation), autonomous or semi-autonomous machine applications, advanced computing for real-time streaming and/or high-performance data processing (e.g., using NVIDIA's DGX Cloud), deep learning, environment simulation, object or actor simulation and/or digital twinning, data center processing, conversational AI, light transport simulation (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing advanced computing, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models—such as one or more large language models (LLMs), one or more small language models (SLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

### Example Language Models

In at least some embodiments, language models, such as large language models (LLMs), vision language models (VLMs), small language models SLMs), multi-modal language models (MMLMs), and/or other types of generative artificial intelligence (AI) may be implemented. In some embodiments, one or more functions of the sign language translation system 100 described herein may be implemented, at least in part, using one or more language models. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/VLMs/MMLMs/etc. architectures may be implemented in various embodiments. For example, different architectures may be implemented that use different techniques for understanding and generating outputs—such as text, audio, video, image, 2D and/or 3D design or asset data, etc. In some embodiments, LLMs/VLMs/MMLMs/etc. architectures such as recurrent neural networks (RNNs) or long short-term memory networks (LSTMs) may be used, while in other embodiments transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/VLMs/MMLMs/etc. may also include one or more diffusion block(s) (e.g., denoisers). The LLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/VLMs/MMLMs/etc. that include both encoder and decoder components like T5 (Text-to-Text Transformer) may be implemented to understand and generate content, such as for translation and summarization. These examples are not intended to be limiting, and any architecture type including but not limited to those described herein—may be implemented depending on the particular embodiment and the task(s) being performed using the LLMs/VLMs/MMLMs/etc.

In various embodiments, the LLMs/VLMs/MMLMs/etc. may be trained using unsupervised learning, in which an LLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

In some embodiments, multiple language models (e.g., LLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g., updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 6A is a block diagram of an example generative language model system 600 suitable for use in implementing at least some embodiments of the present disclosure. In the example illustrated in FIG. 6A, the generative language model system 600 includes a retrieval augmented generation (RAG) component 692, an input processor 605, a tokenizer 610, an embedding component 620, plug-ins/APIs 695, and a generative language model (LM) 630 (which may include an LLM, a VLM, a multi-modal LM, etc.). In some embodiments, one or more functions of the sign language translation system 100 described herein may be implemented using features similar to those of the generative language model system 600.

At a high level, the input processor 605 may receive an input 601 comprising text and/or other types of input data (e.g., audio data, video data, image data, sensor data (e.g., LiDAR, RADAR, ultrasonic, etc.), 3D design data, CAD data, universal scene descriptor (USD) data such as OpenUSD, etc.), depending on the architecture of the generative LM 630 (e.g., LLM/VLM/MMLM/etc.). In some embodiments, the input 601 includes plain text in the form of one or more sentences, paragraphs, and/or documents. Additionally or alternatively, the input 601 may include numerical sequences, precomputed embeddings (e.g., word or sentence embeddings), and/or structured data (e.g., in tabular formats, JSON, or XML). In some implementations in which the generative LM 630 is capable of processing multi-modal inputs, the input 601 may combine text (or may omit text) with image data, audio data, video data, design data, USD data, and/or other types of input data, such as but not limited to those described herein. Taking raw input text as an example, the input processor 605 may prepare raw input text in various ways. For example, the input processor 605 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 605 may remove stopwords to reduce noise and focus the generative LM 630 on more meaningful content. The input processor 605 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 692 (which may include one or more RAG models, and/or may be performed using the generative LM 630 itself) may be used to retrieve additional information to be used as part of the input 601 or prompt. RAG may be used to enhance the input to the LLM/VLM/MMLM/etc. with external knowledge, so that answers to specific questions or queries or requests are more relevant—such as in a case where specific knowledge is required. The RAG component 692 may fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some embodiments, the input 601 may be generated using the query or input to the model (e.g., a question, a request, etc.) in addition to data retrieved using the RAG component 692. In some embodiments, the input processor 605 may analyze the input 601 and communicate with the RAG component 692 (or the RAG component 692 may be part of the input processor 605, in embodiments) in order to identify relevant text and/or other data to provide to the generative LM 630 as additional context or sources of information from which to identify the response, answer, or output 690, generally. For example, where the input indicates that the user is interested in a desired tire pressure for a particular make and model of vehicle, the RAG component 692 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 692 may retrieve a prior stored conversation history—or at least a summary thereof—and include the prior conversation history along with the current ask/request as part of the input 601 to the generative LM 630.

The RAG component 692 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 692 and the embeddings of the chunks along with the embeddings of the query may be compared to identify the most similar/related embeddings to the query, which may be supplied to the generative LM 630 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 692 may implement a plugin, API, user interface, and/or other functionality to perform RAG. For example, a graph RAG plug-in may be used by the LLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 610 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 630 to understand morphological variations and handle out-of-vocabulary words more effectively. Character-based tokenization represents each character as a separate token, enabling the generative LM 630 to process text at a fine-grained level. The choice of tokenization strategy may depend on factors such as the language being processed, the task at hand, and/or characteristics of the training dataset. As such, the tokenizer 610 may convert the (e.g., processed) text into a structured format according to tokenization schema being implemented in the particular embodiment.

The embedding component 620 may use any known embedding technique to transform discrete tokens into (e.g., dense, continuous vector) representations of semantic meaning. For example, the embedding component 620 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 601 includes image data/video data/etc., the input processor 605 may resize the data to a standard size compatible with format of a corresponding input channel and/or may normalize pixel values to a common range (e.g., 0 to 1) to ensure a consistent representation, and the embedding component 620 may encode the image data using any known technique (e.g., using one or more convolutional neural networks (CNNs) to extract visual features). In some implementations in which the input 601 includes audio data, the input processor 605 may resample an audio file to a consistent sampling rate for uniform processing, and the embedding component 620 may use any known technique to extract and encode audio features—such as in the form of a spectrogram (e.g., a mel-spectrogram). In some implementations in which the input 601 includes video data, the input processor 605 may extract frames or apply resizing to extracted frames, and the embedding component 620 may extract features such as optical flow embeddings or video embeddings and/or may encode temporal information or sequences of frames. In some implementations in which the input 601 includes multi-modal data, the embedding component 620 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 630 and/or other components of the generative LM system 600 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 620 may apply an encoded representation of the input 601 to the generative LM 630, and the generative LM 630 may process the encoded representation of the input 601 to generate an output 690, which may include responsive text and/or other types of data.

As described herein, in some embodiments, the generative LM 630 may be configured to access or use—or capable of accessing or using—plug-ins/APIs 695 (which may include one or more plug-ins, application programming interfaces (APIs), databases, data stores, repositories, etc.). For example, for certain tasks or operations that the generative LM 630 is not ideally suited for, the model may have instructions (e.g., as a result of training, and/or based on instructions in a given prompt, such as those retrieved using the RAG component 692) to access one or more plug-ins/APIs 695 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 695 to the plug-in/API 695, the plug-in/API 695 may process the information and return an answer to the generative LM 630, and the generative LM 630 may use the response to generate the output 690. This process may be repeated—e.g., recursively—for any number of iterations and using any number of plug-ins/APIs 695 until an output 690 that addresses each ask/question/request/process/operation/etc. from the input 601 can be generated. As such, the model(s) may not only rely on its own knowledge from training on a large dataset(s) and/or from data retrieved using the RAG component 692, but also on the expertise or optimized nature of one or more external resources—such as the plug-ins/APIs 695.

FIG. 6B is a block diagram of an example implementation in which the generative LM 630 includes a transformer encoder-decoder. For example, assume input text such as “Who discovered gravity” is tokenized (e.g., by the tokenizer 610 of FIG. 6A) into tokens such as words, and each token is encoded (e.g., by the embedding component 620 of FIG. 6A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 635 of the generative LM 630.

In an example implementation, the encoder(s) 635 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 640 may convert the context vector into attention vectors (keys and values) for the decoder(s) 645.

In an example implementation, the decoder(s) 645 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 635, in an example transformer architecture, each token (e.g., word) flows through a separate path in the decoder(s) 645. During a first pass, the decoder(s) 645, a classifier 650, and a generation mechanism 655 may generate a first token, and the generation mechanism 655 may apply the generated token as an input during a second pass. The process may repeat in a loop, successively generating and adding tokens (e.g., words) to the output from the preceding pass and applying the token embeddings of the composite sequence with positional encodings as an input to the decoder(s) 645 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 635, except that it creates its queries from the layer below it and takes the keys and values (e.g., matrix) from the output of the encoder(s) 635.

As such, the decoder(s) 645 may output some decoded (e.g., vector) representation of the input being applied during a particular pass. The classifier 650 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 655 may select or sample a word or token based on a corresponding predicted probability (e.g., select the word with the highest predicted probability) and append it to the output from a previous pass, generating each word or token sequentially. The generation mechanism 655 may repeat the process, triggering successive decoder inputs and corresponding predictions until selecting or sampling a symbol or token that represents the end of the response, at which point, the generation mechanism 655 may output the generated response.

FIG. 6C is a block diagram of an example implementation in which the generative LM 630 includes a decoder-only transformer architecture. For example, the decoder(s) 660 of FIG. 6C may operate similarly as the decoder(s) 645 of FIG. 6B except each of the decoder(s) 660 of FIG. 6C omits the encoder-decoder self-attention layer (since there is no encoder in this implementation). As such, the decoder(s) 660 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 660. As with the decoder(s) 645 of FIG. 6B, each token (e.g., word) may flow through a separate path in the decoder(s) 660, and the decoder(s) 660, a classifier 665, and a generation mechanism 670 may use auto-regression to sequentially generate one token at a time until predicting a symbol or token that represents the end of the response. The classifier 665 and the generation mechanism 670 may operate similarly as the classifier 650 and the generation mechanism 655 of FIG. 6B, with the generation mechanism 670 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Computing Device

FIG. 7 is a block diagram of an example computing device(s) 700 suitable for use in implementing some embodiments of the present disclosure. In some embodiments, one or more functions of the sign language translation system 100 described herein may be implemented, at least in part, using the computing device 700. Computing device 700 may include an interconnect system 702 that directly or indirectly couples the following devices: memory 704, one or more central processing units (CPUs) 706, one or more graphics processing units (GPUs) 708, a communication interface 710, input/output (I/O) ports 712, input/output components 714, a power supply 716, one or more presentation components 718 (e.g., display(s)), and one or more logic units 720. In at least one embodiment, the computing device(s) 700 may comprise one or more virtual machines (VMs), and/or any of the components thereof may comprise virtual components (e.g., virtual hardware components). For non-limiting examples, one or more of the GPUs 708 may comprise one or more vGPUs, one or more of the CPUs 706 may comprise one or more vCPUs, and/or one or more of the logic units 720 may comprise one or more virtual logic units. As such, a computing device(s) 700 may include discrete components (e.g., a full GPU dedicated to the computing device 700), virtual components (e.g., a portion of a GPU dedicated to the computing device 700), or a combination thereof.

Although the various blocks of FIG. 7 are shown as connected via the interconnect system 702 with lines, this is not intended to be limiting and is for clarity only. For example, in some embodiments, a presentation component 718, such as a display device, may be considered an I/O component 714 (e.g., if the display is a touch screen). As another example, the CPUs 706 and/or GPUs 708 may include memory (e.g., the memory 704 may be representative of a storage device in addition to the memory of the GPUs 708, the CPUs 706, and/or other components). As such, the computing device of FIG. 7 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 7.

The interconnect system 702 may represent one or more links or busses, such as an address bus, a data bus, a control bus, or a combination thereof. The interconnect system 702 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 706 may be directly connected to the memory 704. Further, the CPU 706 may be directly connected to the GPU 708. Where there is direct, or point-to-point connection between components, the interconnect system 702 may include a PCIe link to carry out the connection. In these examples, a PCI bus need not be included in the computing device 700.

The memory 704 may include any of a variety of computer-readable media. The computer-readable media may be any available media that may be accessed by the computing device 700. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 704 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 700. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 706 may be configured to execute at least some of the computer-readable instructions to control one or more components of the computing device 700 to perform one or more of the methods and/or processes described herein. The CPU(s) 706 may each include one or more cores (e.g., one, two, four, eight, twenty-eight, seventy-two, etc.) that are capable of handling a multitude of software threads simultaneously. The CPU(s) 706 may include any type of processor, and may include different types of processors depending on the type of computing device 700 implemented (e.g., processors with fewer cores for mobile devices and processors with more cores for servers). For example, depending on the type of computing device 700, the processor may be an Advanced RISC Machines (ARM) processor implemented using Reduced Instruction Set Computing (RISC) or an x86 processor implemented using Complex Instruction Set Computing (CISC). The computing device 700 may include one or more CPUs 706 in addition to one or more microprocessors or supplementary co-processors, such as math co-processors.

In addition to or alternatively from the CPU(s) 706, the GPU(s) 708 may be configured to execute at least some of the computer-readable instructions to control one or more components of the computing device 700 to perform one or more of the methods and/or processes described herein. One or more of the GPU(s) 708 may be an integrated GPU (e.g., with one or more of the CPU(s) 706 and/or one or more of the GPU(s) 708 may be a discrete GPU. In embodiments, one or more of the GPU(s) 708 may be a coprocessor of one or more of the CPU(s) 706. The GPU(s) 708 may be used by the computing device 700 to render graphics (e.g., 3D graphics) or perform general purpose computations. For example, the GPU(s) 708 may be used for General-Purpose computing on GPUs (GPGPU). The GPU(s) 708 may include hundreds or thousands of cores that are capable of handling hundreds or thousands of software threads simultaneously. The GPU(s) 708 may generate pixel data for output images in response to rendering commands (e.g., rendering commands from the CPU(s) 706 received via a host interface). The GPU(s) 708 may include graphics memory, such as display memory, for storing pixel data or any other suitable data, such as GPGPU data. The display memory may be included as part of the memory 704. The GPU(s) 708 may include two or more GPUs operating in parallel (e.g., via a link). The link may directly connect the GPUs (e.g., using NVLINK) or may connect the GPUs through a switch (e.g., using NVSwitch). When combined together, each GPU 708 may generate pixel data or GPGPU data for different portions of an output or for different outputs (e.g., a first GPU for a first image and a second GPU for a second image). Each GPU may include its own memory, or may share memory with other GPUs. In some embodiments, one or more functions of the sign language translation system 100 described herein may be executed, at least in part, by the CPU(s) 706 and/or GPU(s) 708.

In addition to or alternatively from the CPU(s) 706 and/or the GPU(s) 708, the logic unit(s) 720 may be configured to execute at least some of the computer-readable instructions to control one or more components of the computing device 700 to perform one or more of the methods and/or processes described herein. In embodiments, the CPU(s) 706, the GPU(s) 708, and/or the logic unit(s) 720 may discretely or jointly perform any combination of the methods, processes and/or portions thereof. One or more of the logic units 720 may be part of and/or integrated in one or more of the CPU(s) 706 and/or the GPU(s) 708 and/or one or more of the logic units 720 may be discrete components or otherwise external to the CPU(s) 706 and/or the GPU(s) 708. In embodiments, one or more of the logic units 720 may be a coprocessor of one or more of the CPU(s) 706 and/or one or more of the GPU(s) 708. In some embodiments, one or more functions of the sign language translation system 100 described herein may be executed, at least in part, by the logic unit(s) 720.

Examples of the logic unit(s) 720 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 710 may include one or more receivers, transmitters, and/or transceivers that allow the computing device 700 to communicate with other computing devices via an electronic communication network, included wired and/or wireless communications. The communication interface 710 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 720 and/or communication interface 710 may include one or more data processing units (DPUs) to transmit data received over a network and/or through interconnect system 702 directly to (e.g., a memory of) one or more GPU(s) 708.

The I/O ports 712 may allow the computing device 700 to be logically coupled to other devices including the I/O components 714, the presentation component(s) 718, and/or other components, some of which may be built in to (e.g., integrated in) the computing device 700. Illustrative I/O components 714 include a microphone, mouse, keyboard, joystick, game pad, game controller, satellite dish, scanner, printer, wireless device, etc. The I/O components 714 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 700. The computing device 700 may be include depth cameras, such as stereoscopic camera systems, infrared camera systems, RGB camera systems, touchscreen technology, and combinations of these, for gesture detection and recognition. Additionally, the computing device 700 may include accelerometers or gyroscopes (e.g., as part of an inertia measurement unit (IMU)) that allow detection of motion. In some examples, the output of the accelerometers or gyroscopes may be used by the computing device 700 to render immersive augmented reality or virtual reality.

The power supply 716 may include a hard-wired power supply, a battery power supply, or a combination thereof. The power supply 716 may provide power to the computing device 700 to allow the components of the computing device 700 to operate.

The presentation component(s) 718 may include a display (e.g., a monitor, a touch screen, a television screen, a heads-up-display (HUD), other display types, or a combination thereof), speakers, and/or other presentation components. The presentation component(s) 718 may receive data from other components (e.g., the GPU(s) 708, the CPU(s) 706, DPUs, etc.), and output the data (e.g., as an image, video, sound, etc.).

### Example Data Center

FIG. 8 illustrates an example data center 800 that may be used in at least one embodiments of the present disclosure. The data center 800 may include a data center infrastructure layer 810, a framework layer 820, a software layer 830, and/or an application layer 840.

As shown in FIG. 8, the data center infrastructure layer 810 may include a resource orchestrator 812, grouped computing resources 814, and node computing resources (“node C.R.s”) 816(1)-816(N), where “N” represents any whole, positive integer. In at least one embodiment, node C.R.s 816(1)-816(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 816(1)-816(N) may correspond to a server having one or more of the above-mentioned computing resources. In addition, in some embodiments, the node C.R.s 816(1)-816(N) may include one or more virtual components, such as vGPUs, vCPUs, and/or the like, and/or one or more of the node C.R.s 816(1)-816(N) may correspond to a virtual machine (VM). In some embodiments, one or more functions of the sign language translation system 100 described herein may be implemented, at least in part, using one or more of the node C.R.s 816(1)-816(N).

In at least one embodiment, grouped computing resources 814 may include separate groupings of node C.R.s 816 housed within one or more racks (not shown), or many racks housed in data centers at various geographical locations (also not shown). Separate groupings of node C.R.s 816 within grouped computing resources 814 may include grouped compute, network, memory or storage resources that may be configured or allocated to support one or more workloads. In at least one embodiment, several node C.R.s 816 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 812 may configure or otherwise control one or more node C.R.s 816(1)-816(N) and/or grouped computing resources 814. In at least one embodiment, resource orchestrator 812 may include a software design infrastructure (SDI) management entity for the data center 800. The resource orchestrator 812 may include hardware, software, or some combination thereof.

In at least one embodiment, as shown in FIG. 8, framework layer 820 may include a job scheduler 828, a configuration manager 834, a resource manager 836, and/or a distributed file system 838. The framework layer 820 may include a framework to support software 832 of software layer 830 and/or one or more application(s) 842 of application layer 840. The software 832 or application(s) 842 may respectively include web-based service software or applications, such as those provided by Amazon Web Services, Google Cloud and Microsoft Azure. The framework layer 820 may be, but is not limited to, a type of free and open-source software web application framework such as Apache Spark™ (hereinafter “Spark”) that may use distributed file system 838 for large-scale data processing (e.g., “big data”). In at least one embodiment, job scheduler 828 may include a Spark driver to facilitate scheduling of workloads supported by various layers of data center 800. The configuration manager 834 may be capable of configuring different layers such as software layer 830 and framework layer 820 including Spark and distributed file system 838 for supporting large-scale data processing. The resource manager 836 may be capable of managing clustered or grouped computing resources mapped to or allocated for support of distributed file system 838 and job scheduler 828. In at least one embodiment, clustered or grouped computing resources may include grouped computing resource 814 at data center infrastructure layer 810. The resource manager 836 may coordinate with resource orchestrator 812 to manage these mapped or allocated computing resources.

In at least one embodiment, software 832 included in software layer 830 may include software used by at least portions of node C.R.s 816(1)-816(N), grouped computing resources 814, and/or distributed file system 838 of framework layer 820. One or more types of software may include, but are not limited to, Internet web page search software, e-mail virus scan software, database software, and streaming video content software.

In at least one embodiment, application(s) 842 included in application layer 840 may include one or more types of applications used by at least portions of node C.R.s 816(1)-816(N), grouped computing resources 814, and/or distributed file system 838 of framework layer 820. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 834, resource manager 836, and resource orchestrator 812 may implement any number and type of self-modifying actions based on any amount and type of data acquired in any technically feasible fashion. Self-modifying actions may relieve a data center operator of data center 800 from making possibly bad configuration decisions and possibly avoiding underutilized and/or poor performing portions of a data center.

The data center 800 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 800. In at least one embodiment, trained or deployed machine learning models corresponding to one or more neural networks may be used to infer or predict information using resources described above with respect to the data center 800 by using weight parameters calculated through one or more training techniques, such as but not limited to those described herein.

In at least one embodiment, the data center 800 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 700 of FIG. 7—e.g., each device may include similar components, features, and/or functionality of the computing device(s) 700. In addition, where backend devices (e.g., servers, NAS, etc.) are implemented, the backend devices may be included as part of a data center 800, an example of which is described in more detail herein with respect to FIG. 8.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments-in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 700 described herein with respect to FIG. 7. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising processing circuitry to:
instantiate one or more sign language translation modules for a session associated with a communication platform;
generate sign language translation data comprising a translation of communication channel data received from the session based at least on a sign language preference of a user;
generate first control data to control animation of at least a portion of a first avatar to perform signing corresponding to the sign language translation data; and
control a user interface for a first client application for the communication platform to present at least the portion of the first avatar performing signing corresponding to the sign language translation data based at least on the first control data.

2. The one or more processors of claim 1, wherein the processing circuitry is further to:
generate a query to a microservices server based at least on the communication channel data; and
generate the sign language translation data based at least on query response data received from the microservices server in response to the query.

3. The one or more processors of claim 1, wherein the communication channel data comprises at least one of audio data or video data from a second client application for the communication platform.

4. The one or more processors of claim 1, wherein the processing circuitry is further to:
generate second control data from at least one of audio data or video data from a second client application to control animation of a second avatar representing a second user; and
control the user interface for the first client application for the communication platform to present the second avatar based at least on the second control data.

5. The one or more processors of claim 1, wherein the animation of the portion of the first avatar comprises at least one of an emotion, a facial expression, or a body animation for the first avatar corresponding to the sign language translation data.

6. The one or more processors of claim 1, wherein the communication channel data comprises a recording of the session, wherein the processing circuitry is to control the user interface for the first client application for the communication platform to present the portion of the first avatar performing signing corresponding to the sign language translation data during playback of the recording of the session.

7. The one or more processors of claim 1, wherein the processing circuitry is further to obtain the sign language preference of the user based at least on a sign language preference setting of the first client application or location information.

8. The one or more processors of claim 1, wherein the processing circuitry is further to analyze the communication channel data to detect a non-verbal cue, wherein the non-verbal cue comprises at least one of a vocal tonality from audio data or a facial expression or video data, wherein the animation of at least the portion of the first avatar is controlled to present a corresponding facial expression that represents the detected non-verbal cue.

9. The one or more processors of claim 1, wherein the processing circuitry is further to:
generate spoken language translation data comprising a translation of communication channel data based at least on a language preference of a second user; and
control the communication platform to audibly present the spoken language translation data for a second client application.

10. The one or more processors of claim 1, wherein the processing circuitry is further to generate the sign language translation data based at least on cultural context for a user based at least on one or more of profile information for the user or previous sessions associated with the communication platform by the user.

11. The one or more processors of claim 1, wherein the one or more processors are comprised in at least one of:
a control system for an autonomous or semi-autonomous machine;
a perception system for an autonomous or semi-autonomous machine;
a system for performing advanced computing;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more language models;
a system implementing one or more large language models (LLMs);
a system implementing one or more small language models (SLMs);
a system implementing one or more vision language models (VLMs);
a system implementing one or more multi-modal language models (MMLMs);
a system for generating synthetic data;
a system for generating synthetic data using AI;
a system incorporating one or more virtual machines (VMs);
a system using or deploying one or more inference microservices;
a system that incorporates one or more machine learning models deployed in a service or microservice along with an OS-level virtualization package;
a system implemented at least partially in a data center; or
a system implemented at least partially using cloud computing resources.

12. A system comprising one or more processors to:
receive communication channel data for a session associated with a communication platform;
generate sign language translation data comprising a translation of the communication channel data based at least on a sign language preference of a user; and
control the communication platform to present a visual representation of the sign language translation data on a user interface of a client application for the communication platform using an instantiated sign language translation module, wherein the visual representation comprises at least a portion of an embodied agent performing signing corresponding to the sign language translation data.

13. The system of claim 12, wherein the one or more processors are further to generate control data to control animation of the portion of the embodied agent, wherein the animation comprises one or more emotions, one or more facial expression, or one or more body animations corresponding to the sign language translation data.

14. The system of claim 12, wherein the one or more processors are further to obtain the sign language preference of the user based at least on a setting of the client application or location information associated with the client application.

15. The system of claim 12, wherein the one or more processors are further to obtain the sign language preference of the user based at least on detecting or inferring a form of sign language from at least one of image data or video data from the client application.

16. The system of claim 12, wherein the communication channel data comprises a recording of the session, wherein the one or more processors are further to control the communication platform to present the portion of the embodied agent via the user interface for the client application during playback of the recording of the session.

17. The system of claim 12, wherein the one or more processors are further to:
generate second control data based at least on video data to control animation of at least a portion of a second embodied agent representing the user of the client application; and
control the communication platform to present the portion of the second embodied agent on the user interface for the client application based at least on the second control data.

18. The system of claim 17, wherein the one or more processors are further to:
generate spoken language translation data comprising a translation of the second control data based at least on a second language preference of a second user; and
control the communication platform to audibly present the spoken language translation data via one or more components of a client device executing a second client application for the communication platform.

19. The system of claim 12, wherein the system is comprised in at least one of:
a control system for an autonomous or semi-autonomous machine;
a perception system for an autonomous or semi-autonomous machine;
a system for performing advanced computing;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more language models;
a system implementing one or more large language models (LLMs);
a system implementing one or more small language models (SLMs);
a system implementing one or more vision language models (VLMs);
a system implementing one or more multi-modal language models (MMLMs);
a system for generating synthetic data;
a system for generating synthetic data using AI;
a system incorporating one or more virtual machines (VMs);
a system using or deploying one or more inference microservices;
a system that incorporates one or more machine learning models deployed in a service or microservice along with an OS-level virtualization package;
a system implemented at least partially in a data center; or
a system implemented at least partially using cloud computing resources.

20. A method comprising:
in response to a sign language communication plug-in for a video conferencing platform being enabled, generating sign language translation data comprising a translation of communication channel data for a conference session associated with the video conferencing platform based at least on a sign language preference of a user; and
controlling a video conferencing platform to present at least a portion of an avatar performing signing corresponding to the sign language translation data on a user interface for a client application based at least on control data generated based at least on the sign language translation data.
